(19) United States
(12) Patent Application Publication
(10) Pub. No.: US 2026/0167573 A1
(43) Pub. Date: Jun. 18, 2026

(54) POLYMER MORTAR WITH SUSTAINED ABSORPTION FUNCTION OF CARBON DIOXIDE AND PREPARATION METHOD THEREFOR

(71) Applicant: Henan Juyan Materials Technology Co., Ltd, Zhengzhou (CN)

(72) Inventors: Zhengqiang Huang, Zhengzhou (CN); Guifeng Huang, Zhengzhou (CN); Yanzhen Wan, Zhengzhou (CN); Maoliang Zhang, Zhengzhou (CN); Xiangjian Du, Zhengzhou (CN); Jiakuo Xu, Zhengzhou (CN); Changju Yang, Zhengzhou (CN); Yibing Wu, Zhengzhou (CN)

(21) Appl. No.: 19/418,891

(22) Filed: Dec. 12, 2025

(30) Foreign Application Priority Data
Dec. 18, 2024 (CN) 202411868219.3

(51) Int. Cl. C04B 28/28; C04B 14/06; C04B 18/14; C04B 24/42; C04B 40/00; C04B 103/30; C04B 103/50; C04B 111/00

(52) U.S. Cl. CPC C04B 28/28; C04B 14/06; C04B 18/146; C04B 24/42; C04B 40/0046; C04B 2103/302; C04B 2103/50; C04B 2111/00019

(57) ABSTRACT

A polymer mortar with a sustained carbon dioxide (CO₂) absorption function includes following raw materials in parts by mass: 500-800 parts of cement, 400-800 parts of quartz sand with a particle size of 10-20 mesh, 400-800 parts of quartz sand with a particle size of 20-40 mesh, 400-800 parts of quartz sand with a particle size of 40-70 mesh, 200-500 parts of quartz sand with a particle size of 70-100 mesh, 20-50 parts of silica fume, 10-30 parts of redispersible polymer powder, 1-5 parts of admixtures, and organic amine accounting for 1%-15% of a total mass of the raw materials. In the present disclosure, the organic amine in the polymer mortar has double-terminal amino groups and includes siloxane bonds, which can form a firm combination with the polymer mortar and capture CO₂ in large quantities continuously.

### CROSS-REFERENCE TO RELATED APPLICATION

This application claims priority of Chinese Patent Application No. 202411868219.3, filed on Dec. 18, 2024, the entire contents of which are incorporated herein by reference.

### TECHNICAL FIELD

The present disclosure relates to the technical field of green building materials, and in particular to a polymer mortar with sustained absorption function of carbon dioxide (CO₂) and a preparation method therefor.

### BACKGROUND

With the increasing population of the world, the demand for improving the quality of life has led to an increase in global CO₂ emissions and a sharp rise in greenhouse gases, posing a threat to people's life systems. Under this background, countries all over the world jointly reduce CO₂ emissions by way of global agreement.

Building materials industry is an important high-energy-consuming and high-emission industry in China, and it is a key industry in controlling and reducing greenhouse gas emissions in China. It is imperative to continuously develop green and low-carbon products. The cement industry is one of the key industries of CO₂ emissions, and its direct carbon emissions account for about ¼ of the total global industrial carbon emissions. China is the country that produces the most cement in the world. In 2020, China's cement output is 24×10⁸ t, accounting for more than half of the total global cement output. The research shows that the direct CO₂ emission of cement industry in China accounts for about 12% of the total CO₂ emission in China, and the industrial process emission accounts for more than 60% of the national industrial process emission. In all aspects of cement manufacturing, although various emission reduction measures have been taken, two steps of fossil fuel combustion and carbonate ore decomposition are still the main sources of carbon emissions. According to the theory of life cycle assessment, cement carbon emissions not only exist in the production stage, but also include CO₂ emissions in transportation, use, service and waste recycling. Therefore, the inevitable carbon emissions in the production process shall be balanced by active carbon capture or solidification measures in the transportation, application, maintenance and recycling stages of cement. In view of the importance of the cement industry in addressing challenges including climate change, environmental risks, and energy resource constraints, it is crucial to perform research on CO₂ capture and fixation technology based on cement as a material to promote the green transformation and high-quality development of the industry.

CO₂ fixation of cement-based materials refers to the capture and fixation of CO₂ in the curing or use stage of cement-based materials. As a technology of mineral CO₂ sequestration, CO₂ fixation of cement-based materials can capture and fix CO₂ in the use stage of cement, offset the CO₂ emitted in the production stage, thereby reducing the carbon emissions in the whole life cycle of cement products, which is a new idea in the research of cement-based materials. However, at present, there are few related studies in this field at home and abroad, and most of the studies focus on the compression capture and separation of CO₂ in the atmosphere. Even if CO₂ capture technology is applied in building materials, the application is mostly achieved through post-impregnation and re-coating methods. This method not only has limited CO₂ capture capacity, but also has short sustainability, cumbersome construction, and has no practical application value.

Therefore, in view of the majestic amount of cement used in China every year, it is necessary to develop cement-based CO₂ fixation materials, that is, a polymer mortar with sustained absorption function of CO₂. Before the material is applied, it has the function of capturing CO₂ and reducing secondary construction, in line with low-carbon emission reduction related policies.

### SUMMARY

Given the problems and deficiencies existing in the related art, an objective of the present disclosure is to provide a polymer mortar with sustained absorption function of CO₂ and a preparation method therefor.

To achieve the objective of the present disclosure, the technical solutions adopted by the present disclosure are as follows.

The present disclosure provides a polymer mortar with sustained absorption function of CO₂, including the following raw materials in parts by mass: 500-800 parts of cement, 400-800 parts of quartz sand with a particle size of 10-20 mesh, 400-800 parts of quartz sand with a particle size of 20-40 mesh, 400-800 parts of quartz sand with a particle size of 40-70 mesh, 200-500 parts of quartz sand with a particle size of 70-100 mesh, 20-50 parts of silica fume, 10-30 parts of redispersible polymer powder, 1-5 parts of admixtures, and organic amine accounting for 1%-15% of a total mass of the raw materials.

The organic amine is a double-terminal primary amine containing siloxane bonds, an amino-terminated hydrosilicone intermediate is prepared by using 1,3-bis(3-aminopropyl)-1,1,3,3-tetramethyldisiloxane as an end-capping agent and via a ring-opening reaction of 1,3,5,7-tetramethylcyclotetrasiloxane (D4H), and the organic amine is prepared by subjecting the intermediate to a hydrosilylation reaction with γ-methacryloxypropyltrimethoxysilane (KH570).

The admixture is one or more selected from water reducers, defoamers, and expansive agents.

Preferably, a molar ratio of the 1,3-bis(3-aminopropyl)-1,1,3,3-tetramethyldisiloxane to the D4H is (4-6):1.

Preferably, a molar ratio of the KH570 to the hydrosilicone intermediate is (0.9-1.1):1.

Preferably, the cement is one or more selected from fly ash cement 425, fly ash cement 525, slag Portland cement 425, slag Portland cement 525, ordinary Portland cement 425, and ordinary Portland cement 525.

Preferably, the redispersible polymer powder is one or more selected from ethylene/vinyl acetate copolymers, vinyl acetate/vinyl versatate copolymers, and acrylic copolymers.

In the present disclosure, the polymer mortar with sustained absorption function of CO₂ has the following carbon fixation mechanisms.

Primary amines and secondary amines readily react with CO₂ to form relatively stable carbamates:

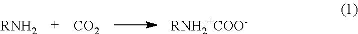

In a high humidity environment, carbamates are partially hydrolyzed:

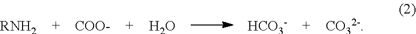

In a strongly alkaline environment, HCO3⁻ is difficult to exist, and CO₃²⁻ is generated:

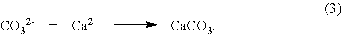

The present disclosure also provides a preparation method for the polymer mortar with sustained absorption function of CO₂, including the steps of: mixing cement, quartz sand with a particle size of 10-20 mesh, quartz sand with a particle size of 20-40 mesh, quartz sand with a particle size of 40-70 mesh, quartz sand with a particle size of 70-100 mesh, silica fume, redispersible polymer powder, admixtures, and organic amine in parts by mass and stirring uniformly the mixture to obtain dry-mixed mortar; and adding water accounting for 10%-15% of the mass of the dry-mixed mortar and mixing uniformly to prepare the polymer mortar.

Preferably, the polymer mortar has a potential of hydrogen (PH) of 12-15.

Preferably, the polymer mortar system has a concentration of hydroxide ions (c(OH⁻)) value of 0.01 mol/L-10 mol/L.

The organic amine is prepared by the following steps:
S1: adding the end-capping agents 1,3-bis(3-aminopropyl)-1,1,3,3-tetramethyldisiloxane and D4H into a reactor equipped with a condensation reflux device, introducing a protective gas, raising the temperature to 70-90° C., adding an alkaline catalyst, and reacting for 7-10 h to obtain the amino-terminated hydrosilicone intermediate with a structure shown in Formula 1; and

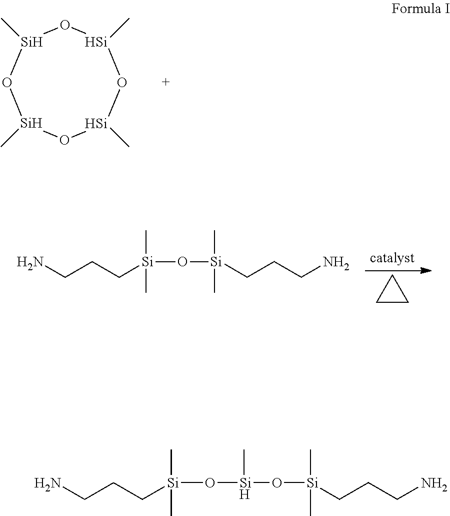

S2, adding toluene and KH570 into the reactor under a protective gas atmosphere, raising the temperature to 60-80° C., adding Karstedt catalyst, adding the amino-terminated hydrosilicone intermediate, reacting for 0.5-3 h, and removing toluene to obtain the organic amine, with a structure shown in Formula 2.

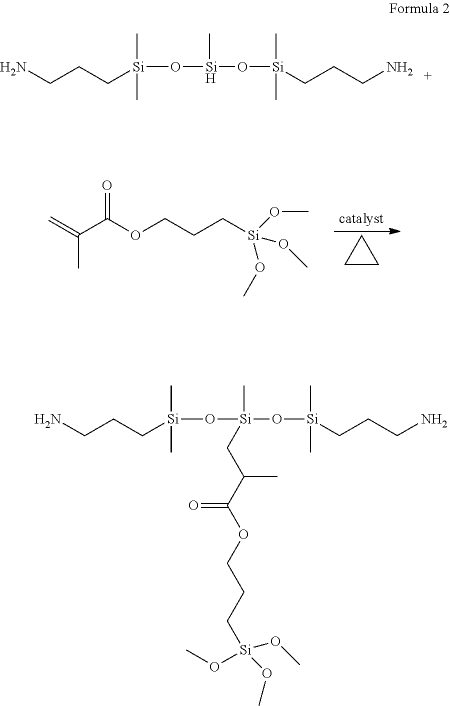

Preferably, the basic catalyst is one or more selected from sodium hydroxide, potassium hydroxide, and tetramethylammonium hydroxide.

Compared with the related art, the present disclosure has the following advantages.
(1) In the present disclosure, by adding an organic amine with a special structure, the organic amine is a double-terminal primary amine including silicon-oxygen bonds, the double-terminal amino organic amine has a large molecular volume, can increase a CO₂ fixation amount and continuously absorb a large amount of CO₂ in the air. The silicon-oxygen bonds of the organic amine can form stronger covalent bonds with the polymer mortar, exhibiting an excellent anchoring effect, avoiding the loss of organic amine in the later stage, and enabling continuous CO₂ capture. In the later stage, the polymer mortar still has an excellent CO₂ capture function in a high-humidity environment.
(2) In the present disclosure, the CO₂ captured by the organic amine in the polymer mortar penetrates into internal pores of the mortar in a high-humidity environment, react with the hydration product inside the cement mortar Ca(OH)₂, and be converted into a large amount of CaCO₃, enabling the organic amine polymer mortar to achieve the objective of CO₂ fixation. Meanwhile, the cured product CaCO₃ is insoluble in water, which fills the cement pores and enhances the mechanical properties.

### BRIEF DESCRIPTION OF THE DRAWINGS

FIG. 1 shows thermogravimetry (TG) and derivative thermogravimetry (DTG) curves of a polymer mortar in a Blank Control 2.

FIG. 2 shows TG and DTG curves of a polymer mortar in Example 5.

### DETAILED DESCRIPTION

Hereinafter, the present disclosure will be described in more detail with reference to examples and the accompanying drawings, but embodiments of the present disclosure are not limited thereto.

### Example 1 Preparation of a Double-Terminal Primary Amine Including Silicon-Oxygen Bonds

The preparation of a double-terminal primary amine including silicon-oxygen bonds includes the following steps.

### In S1, Preparation of Amino-Terminated Hydrosilicone Intermediate by Ring-Opening Reaction of D4H

The end-capping agents 1,3-bis(3-aminopropyl)-1,1,3,3-tetramethyldisiloxane and D4H are added in a molar ratio of 4.5:1 into a reaction vessel equipped with a condensation reflux device, nitrogen is continuously introduced for protection throughout the process, the temperature is raised to 75° C., potassium hydroxide as a catalyst is added, and the reaction is performed for 10 h to obtain an amino-terminated hydrosilicone intermediate with a structure shown in Formula 1.

### In S2: Preparation of a Target Product Via Hydrosilylation Reaction

Toluene and KH570 are added into a reactor under an inert gas protective atmosphere, the temperature is raised to 70° C., Karstedt catalyst is added, and the amino-terminated hydrosilicone intermediate is added into the reaction vessel with a molar ratio of KH570 to the intermediate of 1:1. The reaction is performed at a constant temperature for 1 h, and after the reaction, the solvent toluene is removed to obtain the double-terminal primary amine containing siloxane bonds with a structure shown in Formula 2.

### Example 2

The polymer mortar with sustained absorption function of CO₂ includes the following raw materials in parts by mass:
650 parts of cement;
500 parts of quartz sand (10-20 mesh);
400 parts of quartz sand (20-40 mesh);
450 parts of quartz sand (40-70 mesh);
200 parts of quartz sand (70-100 mesh);
25 parts of silica fume;
15 parts of redispersible polymer powder;
4 parts of admixtures; and
organic amine accounting for 1%-15% of a total mass of the raw materials.

The cement is ordinary Portland cement 425, the redispersible polymer powder is ethylene/vinyl acetate copolymer, the admixture is water reducer, and the organic amine is the double-terminal primary amine containing siloxane bonds prepared in Example 1.

The preparation method of polymer mortar includes the following steps: the raw materials are stirred uniformly to obtain dry-mixed mortar, water accounting for 13% of a mass of the dry-mixed mortar is added and mixed uniformly to prepare the polymer mortar with sustained absorption function of CO₂, and a portion of the slurry is taken to measure the pH value. The remaining mortar is poured into standard molds, cured to final set under standard humidity and temperature conditions, demolded and placed in a carbonization chamber with a CO₂ concentration of 20%, cured for 28 days under standard humidity and temperature conditions, and relevant performance tests are performed in this period.

### Example 3

Example 3 is basically the same as Example 2 except that an amount of organic amine added is 3%.

### Example 4

Example 4 is basically the same as Example 2 except that an amount of organic amine added is 5%.

### Example 5

Example 5 is basically the same as Example 2 except that an amount of organic amine added is 7%.

### Example 6

Example 6 is basically the same as Example 2 except that an amount of organic amine added is 9%.

### Example 7

Example 7 is basically the same as Example 2 except that an amount of organic amine added is 11%.

### Example 8

Example 8 is basically the same as Example 2 except that an amount of organic amine added is 12%.

### Example 9

Example 9 is basically the same as Example 2 except that an amount of organic amine added is 15%.

### Blank Control 1

The raw material composition of Blank Control 1 is basically the same as that of Example 2 except that an amount of organic amine added is 0.

The preparation method of polymer mortar includes the following steps: the raw materials are stirred uniformly to obtain dry-mixed mortar, water accounting for 13% of a mass of the dry-mixed mortar is added and mixed uniformly to prepare the polymer mortar, and a portion of the slurry is taken to measure the pH value. The remaining mortar is poured into standard molds and cured for 28 days under standard humidity and temperature conditions as a blank control group 1.

### Blank Control 2

The raw material composition of Blank Control 2 is basically the same as that of Example 2 except that an amount of organic amine added is 0. The polymer mortar is prepared in the same manner as in Example 2.

### (1) Mechanical Properties Test

The polymer mortars prepared in Examples 2-9 are tested for mechanical properties, and the results are shown in Table 1.

TABLE 1
Test results of mechanical properties
of polymer mortars in Examples 2-9

| | | Initial | | Compressive | | Flexural | |
|---|---|---|---|---|---|---|---|
| | PH | setting | Final setting | strength/MPa | | strength/MPa | |
| Item | value | Time/min | Time/min | 3 d | 28 d | 3 d | 28 d |
| Blank | 11.1 | 62 | 93 | 43.4 | 62.8 | 5.9 | 9.2 |
| Control 1 | | | | | | | |
| Blank | 11.1 | 62 | 93 | 23.5 | 17.4 | 4.2 | 2.2 |
| Control 2 | | | | | | | |
| Example 2 | 11.8 | 58 | 83 | 43.6 | 62.6 | 5.9 | 9.0 |
| Example 3 | 12.4 | 53 | 74 | 43.9 | 62.5 | 6.1 | 8.9 |
| Example 4 | 12.9 | 47 | 64 | 44.1 | 62.0 | 6.2 | 8.9 |
| Example 5 | 13.3 | 40 | 55 | 44.5 | 61.6 | 6.2 | 8.6 |
| Example 6 | 13.8 | 32 | 47 | 44.9 | 61.0 | 6.3 | 8.4 |
| Example 7 | 14.2 | 21 | 33 | 45.3 | 60.3 | 6.4 | 8.3 |
| Example 8 | 14.5 | 12 | 22 | 45.8 | 59.6 | 6.6 | 8.0 |
| Example 9 | 14.7 | 2 | 14 | 46.1 | 55.7 | 7.0 | 7.8 |

From the comparison between Examples 2 to 9 and Blank Control 1, it can be seen that as the amount of organic amine added increases, the pH value of each Example gradually increases, and the initial setting and final setting times become shorter and shorter. This is mainly because the higher alkali content accelerates the early hydration rate of cement and promotes the formation of potassium gypsum, which becomes an important reason for cement flash set. Organic amine affects the mechanical properties of polymer mortar, with the most significant impact on the initial setting time (workability). When the addition amount of organic amine exceeds 10%, due to the excessively short initial setting time (21 min), the mortar almost loses workability. Meanwhile, the higher alkali content slightly improves the strength of cement before 7 days, but reduces the later and long-term strength. Compared with Blank Control 1, Blank Control 2 exhibits significant losses in flexural and compressive strength. This is mainly because, in a high-concentration CO₂ environment, test blocks of Blank Control 2 do not include organic amines capturing CO₂ and cannot sustain an alkaline environment for the hydration system. Consequently, CO₂ penetrates into the interior of the mortar blocks through the pores of the polymer mortar, reacts with Ca²⁺ in the test blocks, and damages the hydrated gel system (cement carbonation), thereby exerting an extremely severe impact on the mechanical properties of the test blocks. Compared with the Blank Control 2, the mechanical properties of Examples 2-9 are better because the organic amine can capture CO₂ and react with Ca(OH)₂ in the cement hydration process to generate water-insoluble CaCO₃, which can fix CO₂ and fill the internal pores of cement to enhance the mechanical properties.

### (2) CO₂ Fixation Test

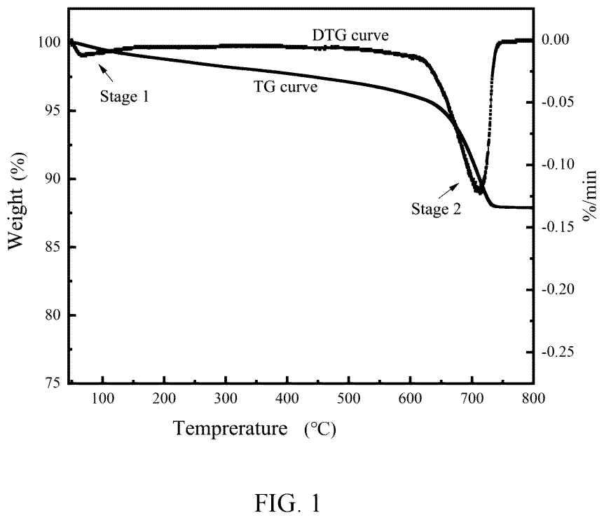

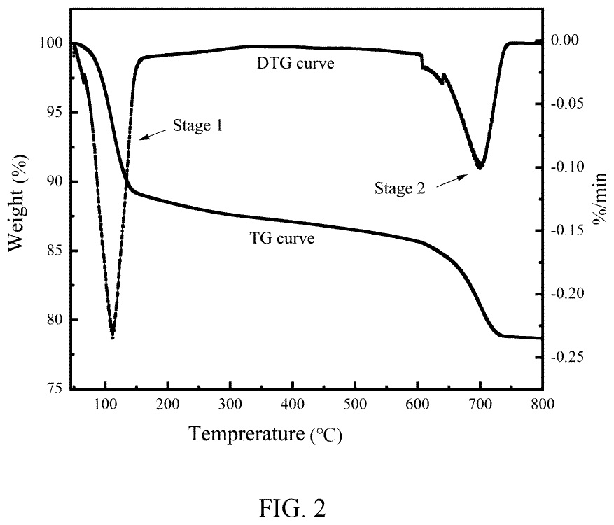

A CO₂ fixation amount can be quantitatively characterized by a thermogravimetric curve using a thermogravimetric analyzer (TGA). The method is as follows. Thermogravimetric analysis is performed on polymer mortar prepared by Blank Control 2 and Example 5, and TG and DTG curves are obtained. The TG and DTG curves of Blank Control 2 are shown in FIG. 1, and those of Example 5 are shown in FIG. 2.

From the comparison of FIG. 1 and FIG. 2, it can be seen that the DTG curves of the samples show two rapid mass loss processes. In Stage 1 (0-120° C.): for Blank Control 2 (FIG. 1), this stage corresponds to the loss of amorphous water in the material; for Example 5 (FIG. 2), the mass loss peak in this stage is larger, which mainly includes two parts: the release of CO₂ captured by the organic amine and the volatilization of amorphous water. In a stage of 150-350° C.: based on the physicochemical properties of the organic amine (boiling point of the self-synthesized organic amine with a special structure is 227.8° C.), it can be inferred that this stage is caused by the volatilization of the organic amine itself, accounting for a small proportion of the total mass loss. In Stage 2 (600-800° C.): CaCO₃ begins to decompose into CaO and CO₂, and the rapid loss of mass in this stage can be seen from the DTG curve. It can be concluded from the figures that, excluding the mass loss in the first stage, the amount of CO₂ released from the decomposition of CaCO₃ in the organic amine-modified cement mortar after CO₂ fixation is greater than that in the reference mortar, indicating that more CaCO₃ is generated after CO₂ fixation of polymer mortar than that of mortar in Blank Controls. Therefore, the quantitative value of CO₂ fixation of polymer mortar can be obtained by calculating the difference between the two.

The polymer mortars prepared in Examples 2-9 are tested for CO₂ fixation by the above method, and the results are shown in Table 2. A calculation formula of CaCO₃ net loss is as follows:

$${W}_{{CaCO}_{3} net loss} = ( W {2}_{Example {CaCO}_{3} decomposition} - W {1}_{Blank Control 2 {CaCO}_{3} decomposition}$$

Calculation formulas of the CO₂ fixation amount are as follows:

$${Ca ( OH )}_{2} + {CO}_{2} = {CaCO}_{3} + {H}_{2} O$$

$$44 \; 100$$

$$M ( {CO}_{2} ) M ( {CaCO}_{3} )$$

$${M ( {CO}_{2} )}_{-} = 0.44 \times M ( {CaCO}_{3} )$$

In the atmospheric environment, no carbonation of the test blocks occurs within a short period, meaning no CO₂ is absorbed. Thus, the net mass loss of CaCO₃ in Blank Control 1 is regarded as 0.

In the absence of organic amine, the amount of CO₂ fixed at 20% carbonization acceleration: Blank Control 2:0.44×(2.77-0)=1.22. In Example 5, the amount of Blank Control fixed by organic amine: 0.44×(57.59-2.77)=24.12.

TABLE 2
CO₂ fixation test results of polymer mortar in Examples 2-9

| | Blank | Blank | | | | | | | | |
|---|---|---|---|---|---|---|---|---|---|---|
| | Control | Control | Example | Example | Example | Example | Example | Example | Example | Example |
| Item | 1 | 2 | 2 | 3 | 4 | 5 | 6 | 7 | 8 | 9 |
| CaCO₃ | 0 | 2.77 | 40.48 | 45.70 | 52.07 | 57.59 | 64.66 | 71.55 | 91.70 | 102.66 |
| net | | | | | | | | | | |
| loss/g | | | | | | | | | | |
| CO₂ | 0 | 1.22 | 16.60 | 18.89 | 21.70 | 24.12 | 27.23 | 30.26 | 39.13 | 43.95 |
| fixation | | | | | | | | | | |
| amount/g | | | | | | | | | | |

It can be seen from Table 2 that as the content of organic amines increases, the content of fixed CO₂ also gradually increases. In Blank Control 2 without organic amines, the amount of fixed CO₂ is extremely low, that is, there is only carbonization. Combined with the test results shown in Table 1, to obtain a polymer mortar having both workability, mechanical properties and CO₂ fixation amount, Example 5 is the most preferred solution among the Examples of the present disclosure.

### Comparative Example 1

The difference from Example 5 is that pentanediamine is selected as the organic amine.

### Comparative Example 2

The difference from Example 5 is that hexamethylene diamine is selected as the organic amine.

### Comparative Example 3

The difference from Example 5 is that heptanediamine is selected as the organic amine.

### Comparative Example 4

The difference from Example 5 is that octanediamine is selected as the organic amine.

### Comparative Example 5

The difference from Example 5 is that nonanediamine is selected as the organic amine.

### Comparative Example 6

The difference from Example 5 is that melamine is selected as the organic amine.

Mechanical properties and CO₂ fixation tests are performed on polymer mortars prepared with different organic amines in Comparative Examples 1 to 6 and Example 5. The results are shown in Table 3. A calculation formula of a growth rate of the fixation amount of CaCO₃ is as follows:

$$W = ( W {2}_{28 D - {CO}_{2} fixation amount} - W {1}_{14 D {CO}_{2} fixation amount} ) / W {1}_{14 D {CO}_{2} fixation amount}$$

TABLE 3
Performance test results of polymer mortars of Comparative Examples 1-6

| | | | | | Growth | | | | |
|---|---|---|---|---|---|---|---|---|---|
| | | Initial | CO₂ | CO₂ | rate of | | | | |
| | | setting | fixation | fixation | CO₂ | Compressive | | Flexural | |
| | | Time/ | amount/ | amount/ | fixation | strength/MPa | | strength/MPa | |
| Item | Organic amines | min | 14 d | 28 d | amount/% | 3 d | 28 d | 3 d | 28 d |
| Example 5 | Example 1 preparation | 40 | 12.17 | 25.34 | 49.01 | 44.5 | 61.6 | 6.2 | 8.6 |
| Comparative | Pentylenediamine | 25 | 13.14 | 20.91 | 37.14 | 45.6 | 55.4 | 6.3 | 5.2 |
| Example 1 | | | | | | | | | |
| Comparative | Hexamethylenediamine | 31 | 11.46 | 19.17 | 40.21 | 44.8 | 56.7 | 6.2 | 5.9 |
| Example 2 | | | | | | | | | |
| Comparative | Heptylenediamine | 38 | 9.92 | 17.14 | 42.15 | 44.8 | 58.7 | 6.1 | 6.3 |
| Example 3 | | | | | | | | | |
| Comparative | Octylenediamine | 41 | 9.02 | 16.33 | 44.78 | 44.9 | 60.1 | 6.1 | 7.5 |
| Example 4 | | | | | | | | | |
| Comparative | Nonanediamine | 44 | 8.78 | 16.01 | 45.14 | 44.9 | 60.7 | 6.1 | 7.7 |
| Example 5 | | | | | | | | | |
| Comparative | Melamine | 60 | 3.17 | 6.23 | 49.11 | 23.9 | 18.1 | 4.4 | 2.1 |
| Example 6 | | | | | | | | | |

From the comparison between Comparative Examples 1-6 and Example 5 in Table 3, it can be seen that with the increase of aliphatic diamine segments in Comparative Examples 1-5, the initial setting time of polymer mortar gradually increases, which conforms to the law that the alkalinity decreases with the increase of segment length after aliphatic diamine is water-dissolved, and the carbon fixation amount decreases in 28 days. From the change in the growth rate of CO₂ fixation amount, it can be seen that aliphatic diamine with shorter segments is easy to precipitate from the pores of polymer mortar in high humidity environment, that is, the durability is poor. In Comparative Example 6, a large volume of melamine is selected as an organic amine. Although the growth rate of CO₂ fixation amount is increased, melamine has poor solubility in water, making it difficult to provide a strong alkaline environment. As a result, it is significantly affected by carbonation, leading to substantial losses in mechanical properties. In Example 5 of the present disclosure, the double-terminal primary amine including siloxane bonds prepared in Example 1 is used in the polymer mortar. This polymer mortar exhibits excellent durability, can still achieve effective CO₂ fixation at 28 days, and simultaneously balances CO₂ fixation performance and mechanical properties. This is because the double-terminal amino organic amine prepared in Example 1 has a large molecular volume, which can increase the CO₂ fixation amount, and at the same time introduces a silicon-oxygen bond, which can form Si—O—Si covalent bonds with the polymer mortar to form a more reliable anchorage, avoid the loss of organic amine in the later stage, and can continuously capture CO₂. The later polymer mortar still has excellent CO₂ capture function in a high humidity environment. At the same time, the organic amine captures CO₂ and reacts with Ca(OH)₂ in the cement hydration process to generate water-insoluble CaCO₃, which can not only achieve CO₂ fixation, but also fill the internal pores of cement and enhance the mechanical properties.

Finally, it is to be noted that the above examples are merely used to describe the technical solutions of the present disclosure, and are not intended to limit the protection scope of the present disclosure. Those skilled in the art can make modifications or equivalent substitutions to the technical solutions of the present disclosure according to the idea of the present disclosure without departing from the essence and scope of the technical solutions of the present disclosure.

1. A polymer mortar with a sustained carbon dioxide (CO₂) absorption function, comprising the following raw materials in parts by mass: 500-800 parts of cement, 400-800 parts of quartz sand with a particle size of 10-20 mesh, 400-800 parts of quartz sand with a particle size of 20-40 mesh, 400-800 parts of quartz sand with a particle size of 40-70 mesh, 200-500 parts of quartz sand with a particle size of 70-100 mesh, 20-50 parts of silica fume, 10-30 parts of redispersible polymer powder, 1-5 parts of admixtures, and organic amine accounting for 1%-15% of a total mass of the raw materials, wherein
the organic amine is a double-terminal primary amine containing siloxane bonds, an amino-terminated hydrosilicone intermediate is prepared by using 1,3-bis(3-aminopropyl)-1,1,3,3-tetramethyldisiloxane as an end-capping agent via a ring-opening reaction of 1,3,5,7-tetramethylcyclotetrasiloxane (D4H), and the organic amine is prepared by subjecting the intermediate to a hydrosilylation reaction with γ-methacryloxypropyltrimethoxysilane (KH570); and
the admixture is one or more selected from water reducers, defoamers, and expansive agents.

2. The polymer mortar according to claim 1, wherein a molar ratio of the 1,3-bis(3-aminopropyl)-1,1,3,3-tetramethyldisiloxane to the D4H is (4-6):1.

3. The polymer mortar according to claim 2, wherein a molar ratio of the KH570 to the hydrosilicone intermediate is (0.9-1.1):1.

4. The polymer mortar according to claim 1, wherein the cement is one or more selected from fly ash cement 425, fly ash cement 525, slag Portland cement 425, slag Portland cement 525, ordinary Portland cement 425, and ordinary Portland cement 525.

5. The polymer mortar according to claim 1, wherein the redispersible polymer powder is one or more selected from ethylene/vinyl acetate copolymers, vinyl acetate/vinyl versatate copolymers, and acrylic copolymers.

6. A preparation method for the polymer mortar with a sustained CO₂ absorption function according to claim 1, comprising the steps of: mixing cement, quartz sand with a particle size of 10-20 mesh, quartz sand with a particle size of 20-40 mesh, quartz sand with a particle size of 40-70 mesh, quartz sand with a particle size of 70-100 mesh, silica fume, redispersible polymer powder, admixtures, and organic amine in parts by mass and stirring uniformly the mixture to obtain dry-mixed mortar; and adding water accounting for 10%-15% of the mass of the dry-mixed mortar and mixing uniformly to prepare the polymer mortar.

7. A preparation method for the polymer mortar with a sustained CO₂ absorption function according to claim 2, comprising the steps of: mixing cement, quartz sand with a particle size of 10-20 mesh, quartz sand with a particle size of 20-40 mesh, quartz sand with a particle size of 40-70 mesh, quartz sand with a particle size of 70-100 mesh, silica fume, redispersible polymer powder, admixtures, and organic amine in parts by mass and stirring uniformly the mixture to obtain dry-mixed mortar; and adding water accounting for 10%-15% of the mass of the dry-mixed mortar and mixing uniformly to prepare the polymer mortar.

8. A preparation method for the polymer mortar with a sustained CO₂ absorption function according to claim 3, comprising the steps of: mixing cement, quartz sand with a particle size of 10-20 mesh, quartz sand with a particle size of 20-40 mesh, quartz sand with a particle size of 40-70 mesh, quartz sand with a particle size of 70-100 mesh, silica fume, redispersible polymer powder, admixtures, and organic amine in parts by mass and stirring uniformly the mixture to obtain dry-mixed mortar; and adding water accounting for 10%-15% of the mass of the dry-mixed mortar and mixing uniformly to prepare the polymer mortar.

9. A preparation method for the polymer mortar with a sustained CO₂ absorption function according to claim 4, comprising the steps of: mixing cement, quartz sand with a particle size of 10-20 mesh, quartz sand with a particle size of 20-40 mesh, quartz sand with a particle size of 40-70 mesh, quartz sand with a particle size of 70-100 mesh, silica fume, redispersible polymer powder, admixtures, and organic amine in parts by mass and stirring uniformly the mixture to obtain dry-mixed mortar; and adding water accounting for 10%-15% of the mass of the dry-mixed mortar and mixing uniformly to prepare the polymer mortar.

10. A preparation method for the polymer mortar with a sustained CO₂ absorption function according to claim 5, comprising the steps of: mixing cement, quartz sand with a particle size of 10-20 mesh, quartz sand with a particle size of 20-40 mesh, quartz sand with a particle size of 40-70 mesh, quartz sand with a particle size of 70-100 mesh, silica fume, redispersible polymer powder, admixtures, and organic amine in parts by mass and stirring uniformly the mixture to obtain dry-mixed mortar; and adding water accounting for 10%-15% of the mass of the dry-mixed mortar and mixing uniformly to prepare the polymer mortar.

11. The preparation method for the polymer mortar according to claim 6, wherein the organic amine is produced by the steps of:
S1: adding the capping agents 1,3-bis(3-aminopropyl)-1,1,3,3-tetramethyldisiloxane and D4H into a reactor, introducing a protective gas, raising the temperature to 70-90° C., adding an alkaline catalyst, and reacting for 7-10 h to obtain the amino-terminated hydrosilicone intermediate; and
S2, adding toluene and KH570 into the reactor under a protective gas atmosphere, raising the temperature to 60-80° C., adding Karstedt catalyst, adding the amino-terminated hydrosilicone intermediate, reacting for 0.5-3 h, and removing toluene to obtain the organic amine.

12. The preparation method for the polymer mortar according to claim 7, wherein the organic amine is produced by the steps of:
S1: adding the capping agents 1,3-bis(3-aminopropyl)-1,1,3,3-tetramethyldisiloxane and D4H into a reactor, introducing a protective gas, raising the temperature to 70-90° C., adding an alkaline catalyst, and reacting for 7-10 h to obtain the amino-terminated hydrosilicone intermediate; and
S2, adding toluene and KH570 into the reactor under a protective gas atmosphere, raising the temperature to 60-80° C., adding Karstedt catalyst, adding the amino-terminated hydrosilicone intermediate, reacting for 0.5-3 h, and removing toluene to obtain the organic amine.

13. The preparation method for the polymer mortar according to claim 8, wherein the organic amine is produced by the steps of:
S1: adding the capping agents 1,3-bis(3-aminopropyl)-1,1,3,3-tetramethyldisiloxane and D4H into a reactor, introducing a protective gas, raising the temperature to 70-90° C., adding an alkaline catalyst, and reacting for 7-10 h to obtain the amino-terminated hydrosilicone intermediate; and
S2, adding toluene and KH570 into the reactor under a protective gas atmosphere, raising the temperature to 60-80° C., adding Karstedt catalyst, adding the amino-terminated hydrosilicone intermediate, reacting for 0.5-3 h, and removing toluene to obtain the organic amine.

14. The preparation method for the polymer mortar according to claim 9, wherein the organic amine is produced by the steps of:
S1: adding the capping agents 1,3-bis(3-aminopropyl)-1,1,3,3-tetramethyldisiloxane and D4H into a reactor, introducing a protective gas, raising the temperature to 70-90° C., adding an alkaline catalyst, and reacting for 7-10 h to obtain the amino-terminated hydrosilicone intermediate; and
S2, adding toluene and KH570 into the reactor under a protective gas atmosphere, raising the temperature to 60-80° C., adding Karstedt catalyst, adding the amino-terminated hydrosilicone intermediate, reacting for 0.5-3 h, and removing toluene to obtain the organic amine.

15. The preparation method for the polymer mortar according to claim 10, wherein the organic amine is produced by the steps of:
S1: adding the capping agents 1,3-bis(3-aminopropyl)-1,1,3,3-tetramethyldisiloxane and D4H into a reactor, introducing a protective gas, raising the temperature to 70-90° C., adding an alkaline catalyst, and reacting for 7-10 h to obtain the amino-terminated hydrosilicone intermediate; and
S2, adding toluene and KH570 into the reactor under a protective gas atmosphere, raising the temperature to 60-80° C., adding Karstedt catalyst, adding the amino-terminated hydrosilicone intermediate, reacting for 0.5-3 h, and removing toluene to obtain the organic amine.

16. The preparation method for the polymer mortar according to claim 11, wherein the basic catalyst is one or more selected from sodium hydroxide, potassium hydroxide, and tetramethylammonium hydroxide.

17. The preparation method for the polymer mortar according to claim 12, wherein the basic catalyst is one or more selected from sodium hydroxide, potassium hydroxide, and tetramethylammonium hydroxide.

18. The preparation method for the polymer mortar according to claim 13, wherein the basic catalyst is one or more selected from sodium hydroxide, potassium hydroxide, and tetramethylammonium hydroxide.

19. The preparation method for the polymer mortar according to claim 14, wherein the basic catalyst is one or more selected from sodium hydroxide, potassium hydroxide, and tetramethylammonium hydroxide.

20. The preparation method for the polymer mortar according to claim 15, wherein the basic catalyst is one or more selected from sodium hydroxide, potassium hydroxide, and tetramethylammonium hydroxide.
